(19) United States
(12) Patent Application Publication
(10) Pub. No.: US 2005/0243370 A1
(43) Pub. Date: Nov. 3, 2005

(54) Print data processing apparatus and method, and program therefor

(75) Inventors: Kiyoshi Imai, Kyoto (JP); Kimitoshi Yoshino, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/088,890

(22) Filed: Mar. 25, 2005

(30) Foreign Application Priority Data
Apr. 30, 2004 (JP) JP2004-135156

(51) Int. Cl. G06F 15/00

(52) U.S. Cl. 358/1.18

(57) ABSTRACT

A contents-file converter converts a contents file inputted to a print data processing apparatus into intermediate files. Then, data on the intermediate files is registered in a page sequence table generated by a page-sequence-table generator. A layout information selector selects a layout information table appropriate to the printer being used for printing. A link processor lays out the intermediate files in respective sections on a printable surface. Accordingly, the data on the intermediate files can be registered even if the printer used for printing has not yet been determined.

### BACKGROUND OF THE INVENTION

1. Field of the Invention

The present invention relates to a print data processing apparatus and method, and a program therefor, in which a printable surface that depends on the printer being used is divided into a plurality of sections, in which then printing objects are laid out.

2. Description of the Background Art

Conventionally, as a technique for imposing page information on a plurality of pages on a printing plate, there is known a technique of imposition design by laying out text or image data on each form according to a page layout table generated previously on a computer.

The number of pages that can be imposed on each printing plate usually depends on the printer being used. That is, the maximum size of printed matter that can be printed depends on the printer, and the number of pages that can be imposed on each printing plate is determined based on that maximum size. Thus, conventional methods of imposing pages of printed matter, first of all, specify a printer being used for printing and then selects a page layout table based on the printer specified. The imposition design is then performed based on the selected page layout table.

However, depending on the circumstances of the printing process, for example we may find ourselves in such a situation that an originally-planned printer cannot be used due to other urgent print jobs and thus a different printer must be used for printing. In such a case, if the originally-planned printer and the printer being actually used for printing have different numbers of pages that can be imposed, it becomes necessary to start over the imposition design process hitherto performed. This results in problems of increased number of process steps for imposition, and reduced operating efficiency.

### SUMMARY OF THE INVENTION

The present invention is directed to a print data processing apparatus for dividing a printable surface, which depends on the printer being used, into a plurality of sections and laying out printing objects in respective ones of the plurality of sections.

According to the present invention, the print data processing apparatus includes a storage for holding a plurality of separate tables. The plurality of separate tables include a plurality of layout information tables provided for each size of the printable surface and each containing, at least, data on respective ones of the plurality of sections and data on the printing objects laid out in respective ones of the plurality of sections; and a page information table containing, as no unique data, data on nonunique ones of the printing objects which are not unique to the printable surface. The print data processing apparatus further includes a register for registering the nonunique data in the page information table; a selector for selecting one of the plurality of layout information tables which is appropriate to a printer being used for printing; and a linker for establishing a link between the nonunique data in the page information table and data corresponding to the nonunique data in a selected layout information table obtained by the selector, so that the nonunique printing objects are laid out in corresponding ones of the plurality of sections.

Thus, data on the nonunique printing objects can be registered even if a printer being used for printing has not yet been determined. This allows efficient print-data processing.

Preferably, the plurality of sections each include a layout reference area for use in layout of the printing objects. The nonunique data includes first location information describing relative positions of the nonunique printing objects and virtual layout reference areas of nearly identical shape with the layout reference areas, when the nonunique printing objects are laid out on the virtual layout reference areas. The layout information tables each contain, as data on the nonunique printing objects, orientation information describing an orientation of the nonunique printing object in a target one of the plurality of sections; second location information describing a position of the layout reference area in the target section as viewed from a reference point on the printable surface; and third location information computed based on the orientation information and the first and second location information and describing a position of the nonunique printing object in the target section as viewed from the reference point. The register computes the first location information and stores nonunique data including the first location information in the page information table. The linker computes and stores the third location information as data on the nonunique printing objects.

Thus, the non-unique printing objects can be assigned to respective sections on the printable surface, irrespective of the type of the printer being used for printing.

The present invention is also directed to a program being readable by a computer and for dividing a printable surface, which depends on a printer, into a plurality of sections and laying out printing objects in respective ones of the plurality of sections.

According to the present invention, the computer includes a storage for holding a plurality of separate tables including a plurality of layout information tables. The layout information tables are provided for each size of the printable surface and each contain, at least, data on respective ones of the plurality of sections and data on the printing objects laid out in respective ones of the plurality of sections; and a page information table for storing, as nonunique data, data on nonunique ones of the printing objects which are not unique to the printable surface. In execution of the program, the computer performs the steps of registering the nonunique data in the page information table; selecting one of the plurality of layout information tables which is appropriate to a printer being used for printing; and establishing a link between the nonunique data in the page information table and data corresponding to the nonunique data in the selected layout information table, so that the nonunique printing objects are laid out in corresponding ones of the plurality of sections.

Thus, the data on the nonunique printing objects can be registered even if a printer used for printing has not yet been determined. This allows efficient print-data processing.

Accordingly, an object of the present invention is to provide a print data processing apparatus and method, and a program therefor, in which printing objects can be laid out in respective ones of a plurality of sections on a printable surface without depending on the printer being used for printing.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of the structure of a printing system according to a preferred embodiment of the present invention;

FIG. 2 is a block diagram for explaining a functional structure of a print data processing apparatus;

FIG. 3 is a diagram for explaining conversion of a contents file;

FIG. 4 shows an example of the data structure of a page sequence table;

FIG. 5 shows an example of the data structure of a layout information table in conventional techniques;

FIG. 6 shows an example of the data structure of a layout information table according to the preferred embodiment of the present invention;

FIGS. 7 and 8 are diagrams for explaining an imposition design on a printable surface;

FIGS. 9 and 10 are diagrams for explaining contents data laid out on a printable surface;

FIG. 11 is a diagram for explaining the relationship between a virtual layout reference area and a print area;

FIGS. 12 to 14 are diagrams for explaining the relative offsets of the lower left corner of the print area from the lower left corner of the virtual layout reference area;

FIG. 15 is a diagram for explaining linking of the page sequence table and the layout information table;

FIGS. 16 to 19 are diagrams for explaining the absolute offsets of the print area from the lower left corner of a printing plate;

FIG. 20 is a flow chart showing the procedure of data processing in the print data processing apparatus; and

FIG. 21 is a diagram for explaining a double-page spread of printed matter.

### DESCRIPTION OF THE PREFERRED EMBODIMENTS

Hereinbelow, a preferred embodiment of the present invention is described in detail with reference to the drawings.

<1. Structure of Printing System>

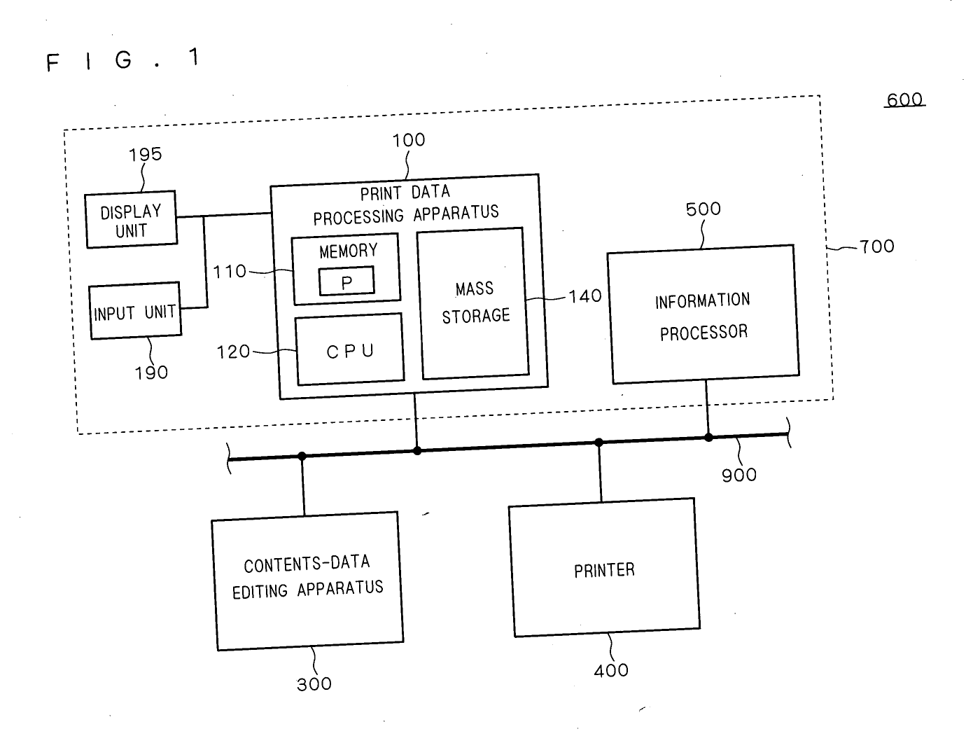

FIG. 1 is a diagram showing an example of the structure of a printing system 600 according to a preferred embodiment of the present invention. The printing system 600 is a system for performing imposition in which input print data is laid out in a predetermined location on a printable surface 200 (see for example FIG. 7) and for performing printing based on imposition information as to print data (layout information) generated during the imposition. As shown in FIG. 1, the printing system 600 includes a contents-data editing apparatus 300, a print data processing apparatus 100, and a printer 400, each of which is electrically connected to the others over a network 900.

The network 900 is connected not only to the print data processing apparatus 100 but also to an information processor 500 that is capable of computing and processing information. Thus, the apparatuses and devices 100, 300, 400, and 500 respectively can transmit and receive data to and from the others over the network 900.

The contents-data editing apparatus 300 is an apparatus for generating and editing contents data (print data) such as document and image data and is configured by a so-called personal computer or work station. The contents data generated is stored in a storage (not shown) of the contents-data editing apparatus 300 as, for example, a PDF (Portable Document Format) file or a PS (PostScript) file (the PostScript is a registered trademark). The file stored in the storage is then inputted into the print data processing apparatus 100 as a contents file 175.

The print data processing apparatus 100 is an apparatus for performing imposition (imposition design) in which document and/or image data included in the contents file 175 which is inputted from the contents-data editing apparatus 300 are laid out in predetermined locations on the printable surface 200 displayed on a display unit 195. Here, the printable surface 200 is a flat or curved surface that depends on the printing performance of the printer 400, i.e., the maximum size of printed matter that can be printed by the printer 400. Thus, the printable surface 200 depends on the type of the printer 400.

The imposition information (layout information) as to the contents data 175 including document and/or image data laid out on the printable surface 200 is stored in a page sequence table 160 and a layout information table 150 which are described in detail later.

As shown in FIG. 1, the print data processing apparatus 100 primarily includes a memory 110 for storing a program P, variables, and the like; a CPU 120 which performs control according to the program P stored in the memory 110; and a mass storage 140.

According to the program P stored in the memory 110, the CPU 120 performs for example conversion of the contents file 175 into intermediate files 170 and linkage establishment between the page sequence table 160 (cf. FIG. 4) and the layout information table 150 (cf. FIG. 6) with predetermined timing, both of which operations are described in detail later.

The mass storage 140 is a storage such as a silicon disk drive or a hard disk drive which consists of elements having larger storage capacities than those of the memory 110. The mass storage 140 can thus store a plurality of programs such as the program P executed by the CPU 120 and a plurality of data files including the page sequence table 160 which will be described later (cf. FIG. 4), the intermediate files 170 (cf. FIG. 3), the contents file 175 (cf. FIG. 3), and the layout information table 150 (cf. FIG. 6). The mass storage 140, as necessary, transmits and receives data and the program P to and from the memory 110.

The input unit 190 is an input device which is a so-called mouse or keyboard (not shown). The operator can, according to the display on the display unit 195, input a total number of pages that is necessary for generation of the page sequence table 160, and the like.

The printer 400 is a device for generating a printing plate based on the imposition information generated by the print data processing apparatus 100 and for performing printing on an object to be printed, by using the printing plate. Depending on the device configuration of the printer 400, direct printing on an object to be printed is possible without using the printing plate. Or, the printing plate generated by the printer 400 may be used in other printers.

<2. Functional Structure of Print Data Processing Apparatus>

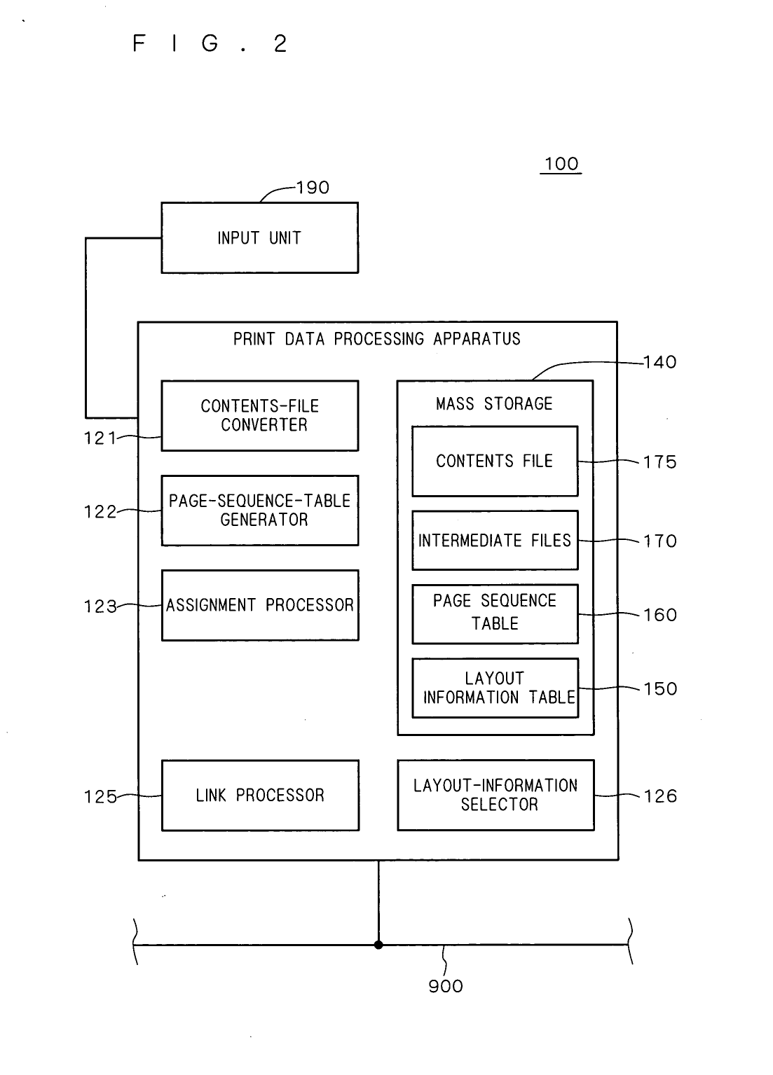

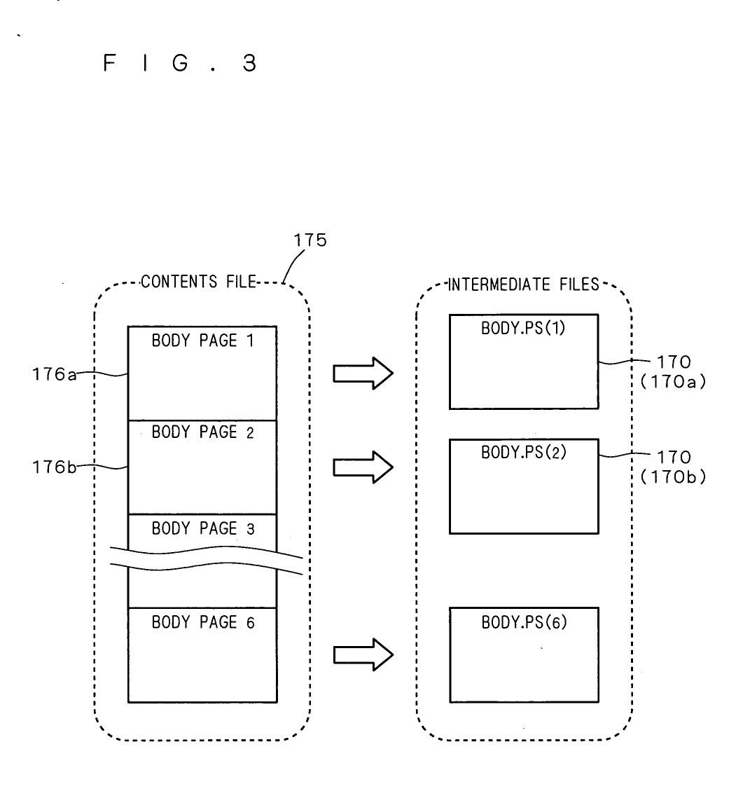

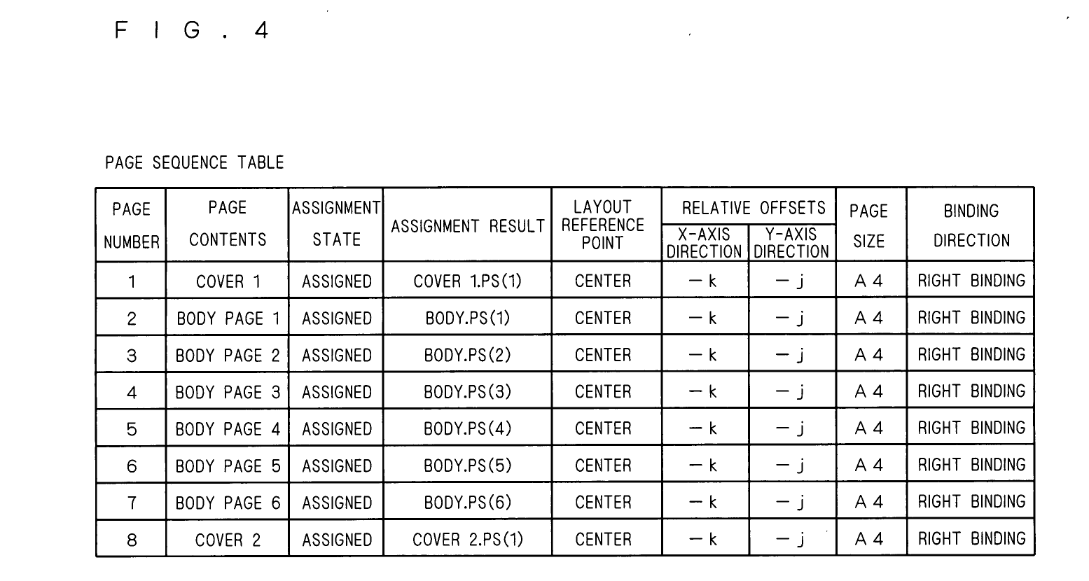

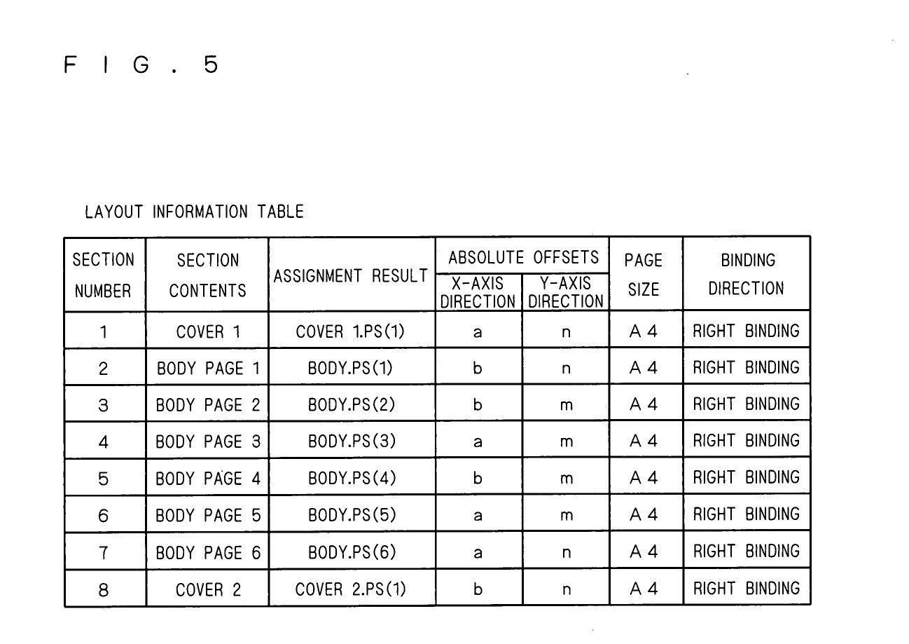

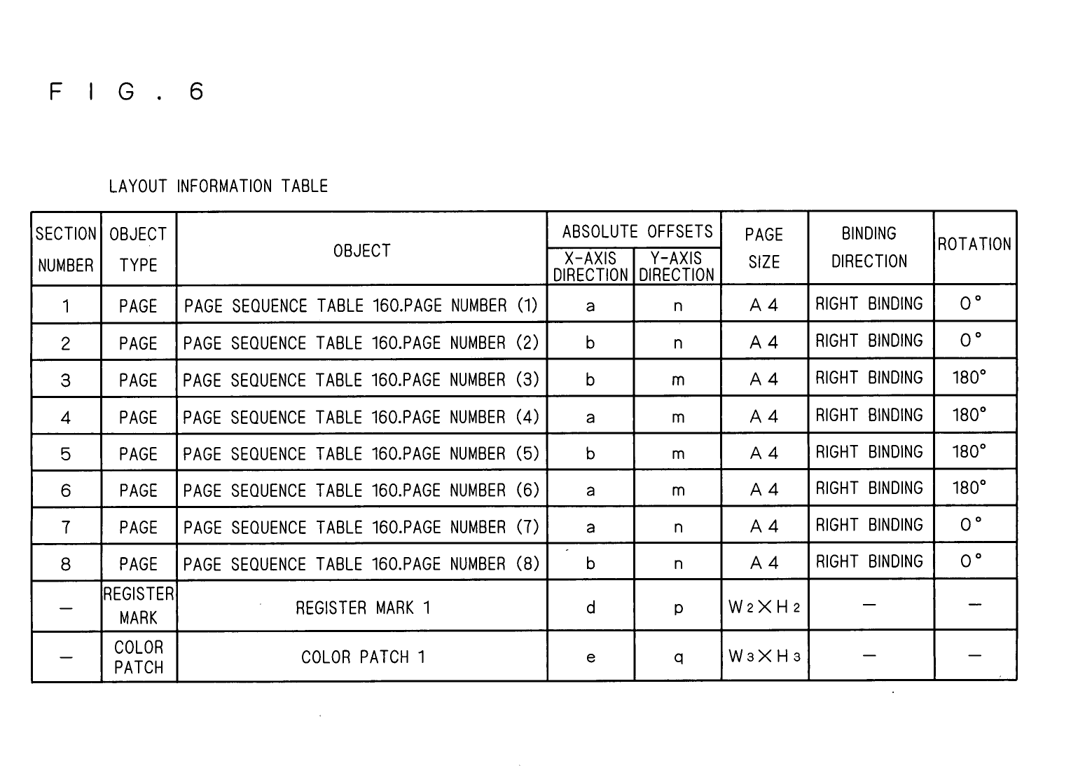

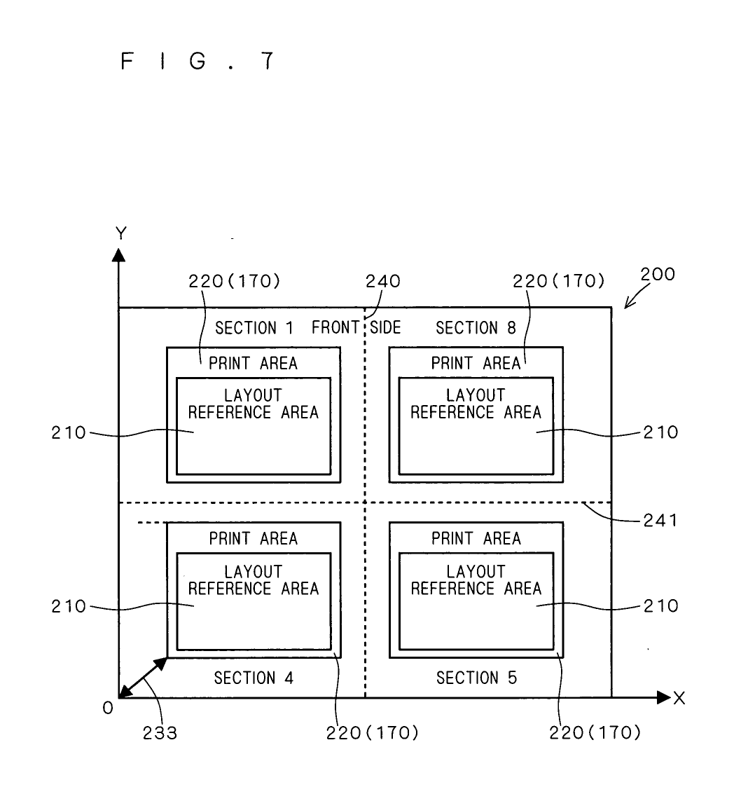

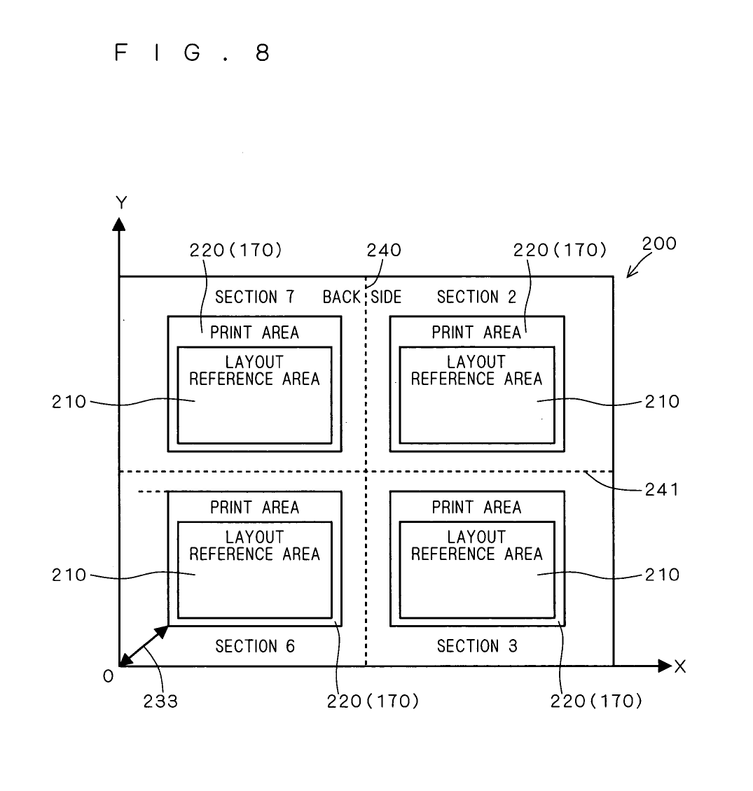

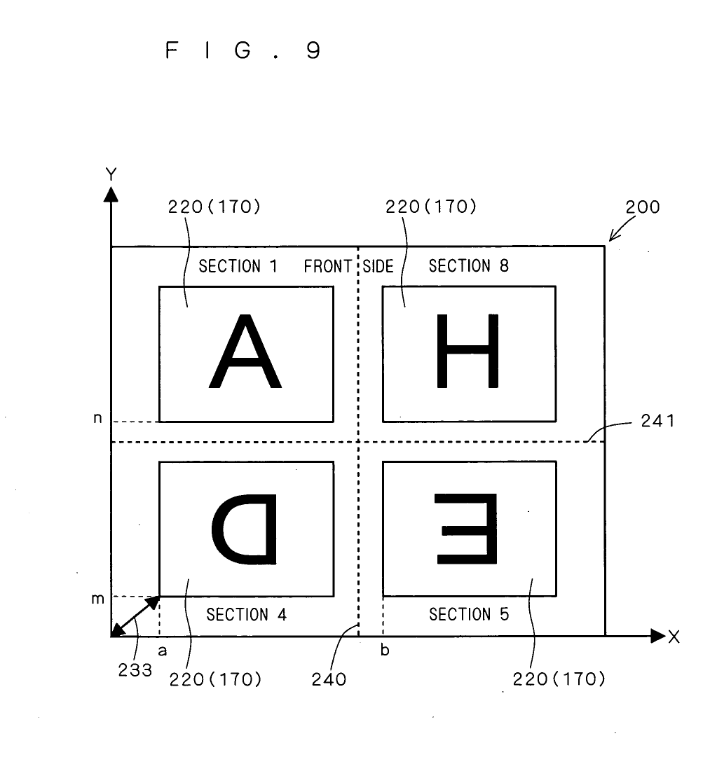

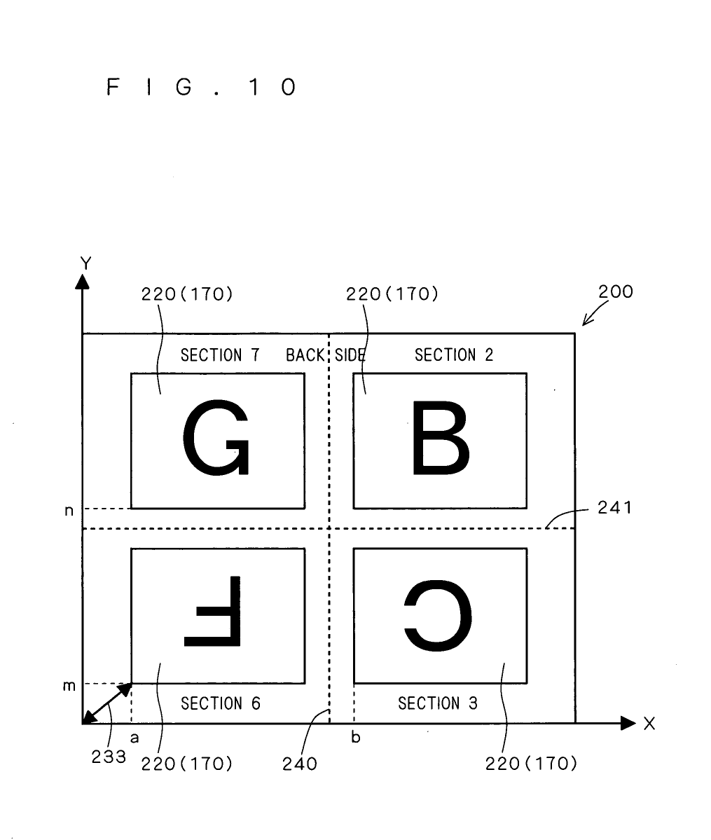

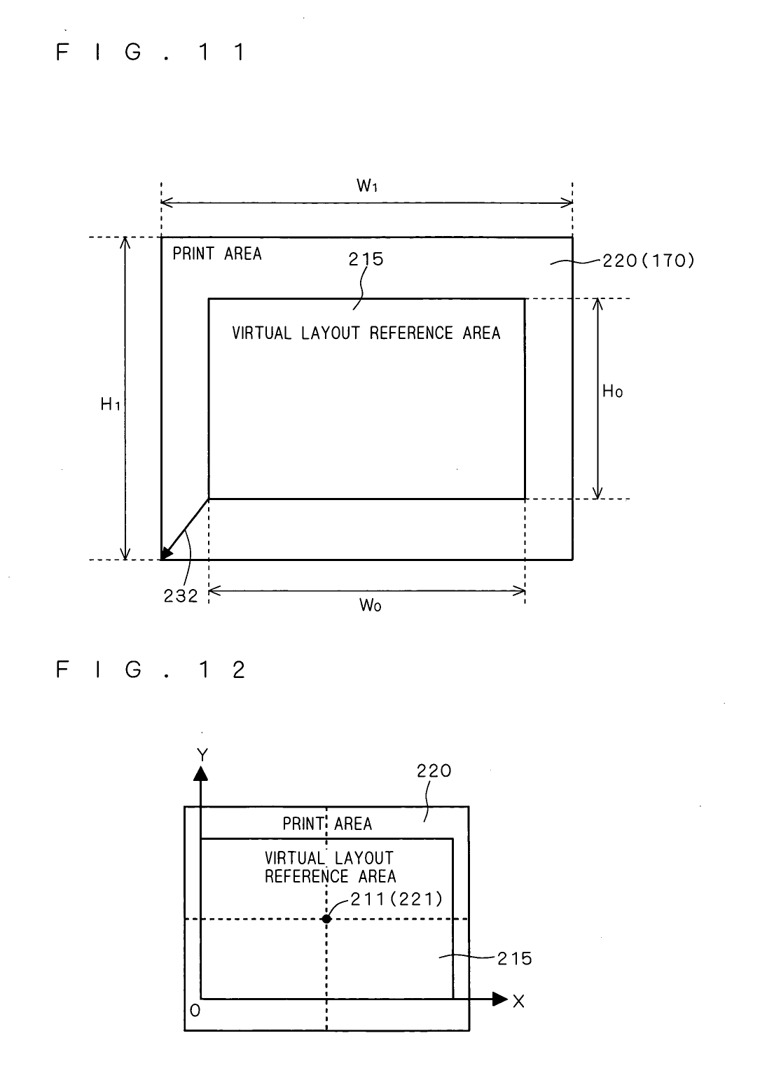

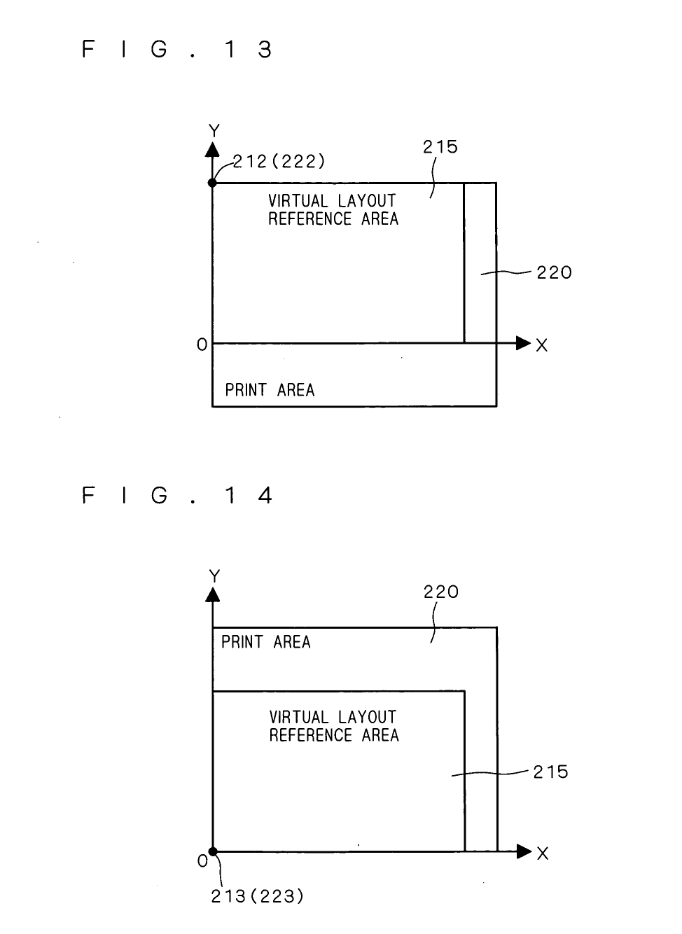

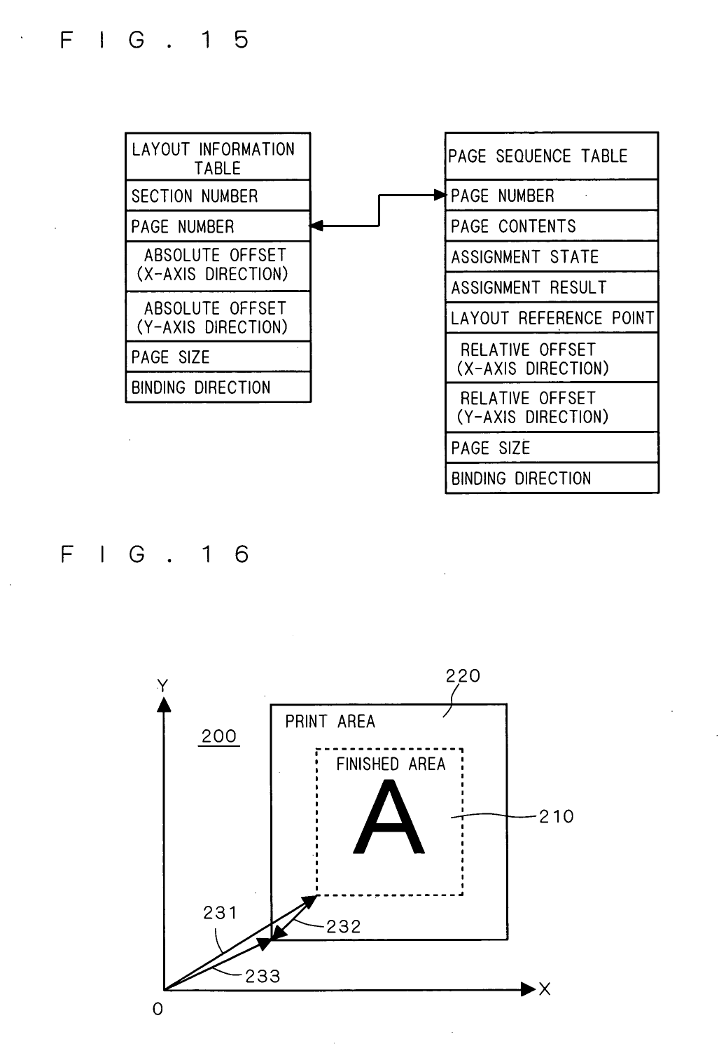

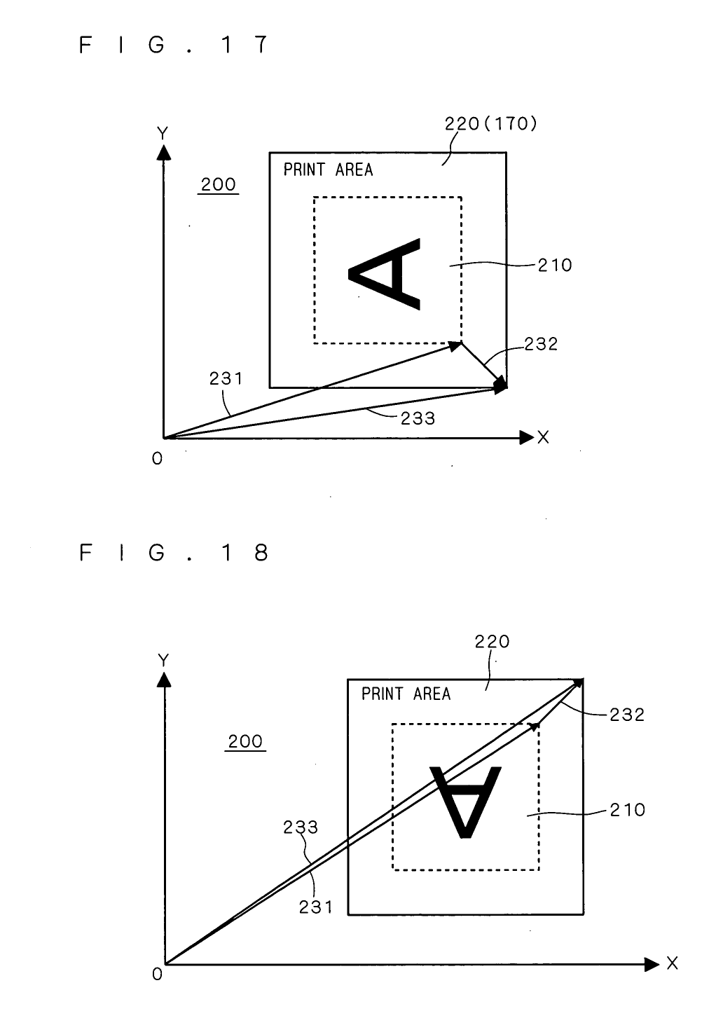

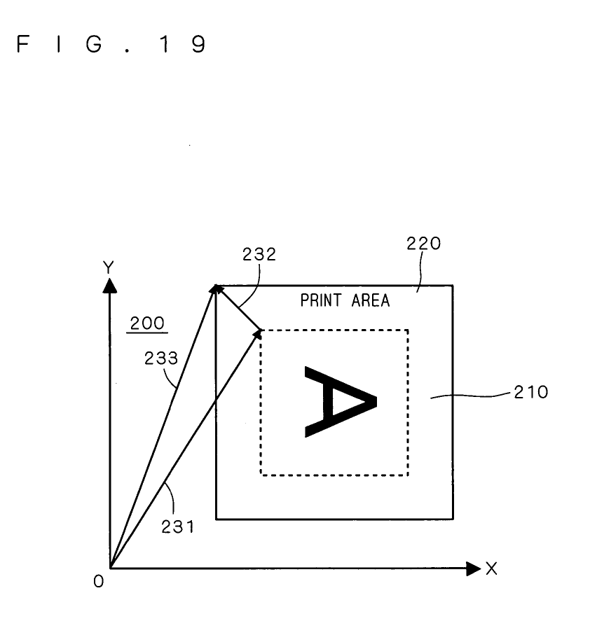

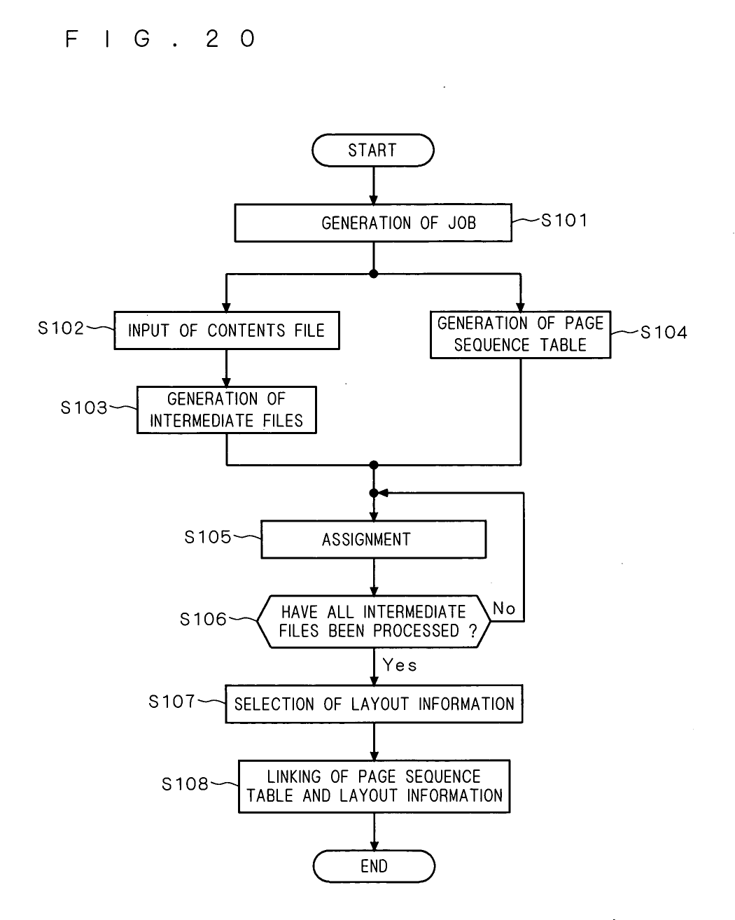

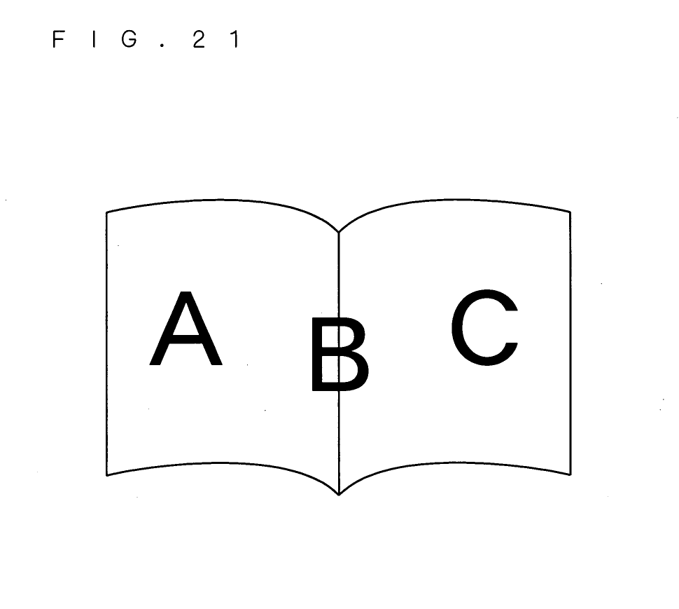

FIG. 2 is a diagram for explaining the functional structure of the print data processing apparatus 100. FIG. 3 is a diagram for explaining conversion of the contents file 175. A contents-file converter 121 performs conversion of the contents file 175 inputted from the contents-data editing apparatus 300 into the intermediate files 170.

More specifically, the contents file 175 which has been transmitted from the contents-data editing apparatus 300 to the print data processing apparatus 100 over the network 900 is once held in the mass storage 140. The contents-file converter 121 refers to the contents file 175 stored in the mass storage 140 to obtain a total number of pages of the contents file 175 and the size of each page (e.g., A4).

The contents-file converter 121 also converts data on each page of the contents file 175 into a file format appropriate to data processing in the print data processing apparatus 100 and generates the intermediate files 170 corresponding to the respective pages (see FIG. 3). For example, body data 176a and 176b in the contents file 175 are converted into intermediate files 170a and 170b, respectively.

A page-sequence-table generator 122 generates the page sequence table 160 for registering data on the intermediate files 170. An assignment processor 123 performs registration of data on the intermediate files 170 into the page sequence table 160.

A layout-information selector 126 selects the layout information table 150 responsive to the printable surface 200 which depends on the printer 400. A link processor 125 establishes a link between the layout information table 150 selected by the layout-information selector 126 and the page sequence table 160 which contains data on the intermediate files 170 registered by the assignment processor 123.

Detailed descriptions of the page-sequence-table generator 122, the assignment processor 123, the layout-information selector 126, and the link processor 125 are given hereinbelow with descriptions of the data structures of the page sequence table 160 and the layout information table 150.

FIG. 4 shows an example of the data structure of the page sequence table 160. The page sequence table 160 is a database for setting, for example in the case of book printing, print data (intermediate file 170) to be printed on each page. As shown in FIG. 4, the page sequence table 160 primarily contains fields (columns) including “Page Number,” “Page Contents,” “Assignment State,” “Assignment Result,” “Layout Reference Point,” “Relative Offset (X-axis Direction),” “Relative Offset (Y-axis Direction),” “Page Size,” and “Binding Direction.”

A total number of pages of a book is usually determined at the stage of planning a book. Thus, by inputting from the input unit 190 the total number of pages determined at the planning stage, the page-sequence-table generator 122 may generate the page sequence table 160 which contains as many records as the total number of pages with empty fields. Or, the page sequence table 160 may be generated based on the total number of pages of the contents file 175 obtained by the contents-file converter 121.

The “Page Number” field in the page sequence table 160 stores the value for uniquely identifying each record (each row) in the page sequence table 160.

The “Assignment State” field stores the value indicating whether data on the intermediate file 170 has been registered in each record. That is, if the assignment processor 123 has already performed assignment, the “Assignment State” field stores the value, “assigned”. If the assignment has not yet been performed, the “Assignment State” field stores the value, “unassigned.” In the “Assignment Result” field, the file name of the assigned intermediate file 170 is registered.

The “Page Contents” field stores a description of the intermediate file 170 registered in each record. For example, the “Page Contents” field of the record (row) whose “Page Number” is “2” stores “Body Page 1.” This indicates that, in this record, the intermediate file 170 as to page 1 of the body of a document is registered (or will be registered, in the case where the “Assignment State” is “unassigned”).

The contents of print data registered in each record in the page sequence table 160 can be determined at the stage of planning a book. Thus, the value of the “Page Contents” field may be registered prior to the assignment process.

The “Page Size” field stores the value indicating the print size (e.g., paper size based on JIS standard such as A4 and A3) at which size the printer 400 will actually print the intermediate file 170 registered in each record. The “Binding Direction” field stores the value indicating the direction of binding of a finished book, such as “Left Binding,” “Right Binding,” “Top Binding,” and “Bottom Binding.”

The “Layout Reference Point,” “Relative Offset (X-axis Direction),” and “Relative Offset (Y-axis Direction)” fields store the values for use in computation during the assignment process.

In this way, the page sequence table 160 has the contents data (print data) on each page of a book registered therein, and it is used as a page information table showing the printing status of each page of a book.

Now, the assignment process performed by the assignment processor 123 according to this preferred embodiment will be described in comparison with a conventional assignment process. FIG. 5 shows an example of the data structure of a layout information table 850 according to conventional techniques. FIG. 6 shows an example of the data structure of the layout information table 150 according to this preferred embodiment. FIGS. 7 and 8 show the intermediate files 170 laid out on the printable surface 200 according to data stored in the layout information table 150 or 850.

Finished printed matter such as books is usually obtained through printing on the front side and back side of an object to be printed and subsequent folding and cutting on the printed object. FIGS. 7 and 8 respectively show the front side and back side of the printable surface 200 of an object to be printed.

Prior to the description of conventional techniques of assignment, the layout information table is first described. The layout information tables 150 and 850 are databases for storing data on the printable surface 200. That is, the layout information tables 150 and 850 primarily store: (1) data on each section, e.g., 1-8, of the printable surface 200 which is divided into a plurality of sections (e.g., location information describing the position of a layout reference area 210 in each section as viewed from an origin O of the printable surface 200); (2) information on characters, figures, and lines such as register marks and color patches, which are necessary in printing and binding and to be printed on the printable surface 200; and (3) information on the intermediate files 170 (e.g., location information describing the positions of the intermediate files 170 as viewed from the origin O of the printable surface 200).

As above described, the printable surface 200 depends on the printing performance of the printer 400, that is, the maximum size of printed matter that can be printed by the printer 400. Thus, in this preferred embodiment, a plurality of layout information tables 150 are previously provided according to the performance of the printer 400.

In this preferred embodiment, the layout-information selector 126 selects an appropriate layout information table 150 based on the performance of the printer 400 and on the page size of the intermediate files 170. Similarly, in conventional techniques, an appropriate layout information table 850 is selected by a selector similar to the layout-information selector 126.

In the following description, data consisting of document data (including character strings used for color patches) and/or image data (including figures and lines such as register marks) and location information is especially referred to as an “object.” Among the objects, those which are to be printed, such as the intermediate files 170, register marks, and color patches, are especially referred to as “printing objects.”

The printing objects corresponding to register marks, color patches, and the like are unique to the printable surface 200 since they are laid out in specific locations on the printable surface 200 which depends on the printer 400. On the other hand, the printing objects corresponding to the intermediate files 170 can be laid out on the printable surface 200 of various sizes and can be printed by various printers. Thus, the intermediate files 170 are not unique to a specific printable surface 200. In this preferred embodiment, therefore, the printing objects corresponding to the intermediate files 170 are especially referred to as nonunique printing objects.

For convenience of description, the layout information tables 850 (cf. FIG. 5) and 150 (cf. FIG. 6) are shown to contain only data on the intermediate files 170.

As shown in FIG. 5, the layout information table 850 used in conventional techniques primarily contains fields (columns) including “Section Number,” “Section Contents,” “Assignment State” (not shown), “Assignment Result,” “Absolute Offset (X-axis Direction),” “Absolute Offset (Y-axis Direction),” “Page Size,” and “Binding Direction.”

The “Section Number” field in the layout information table 850 stores the value corresponding to a numerical value of each section, e.g., 1-8 in FIGS. 7 and 8, so that each record (each row) in the layout information table 850 can uniquely be identified.

The “Assignment State” field, like that in the page sequence table 160, stores the value indicating whether data on the intermediate file 170 has been registered in each record (row). That is, if the assignment has already been performed, the “Assignment State” field stores the value, “assigned.” On the other hand, if the assignment has not yet been performed, the “Assignment State” field stores the value, “unassigned.” In the “Assignment Result” field, the file name of the assigned intermediate file 170 is registered.

The “Section Contents” field is similar to the “Page Contents” field in the page sequence table 160 and stores a description of the intermediate file 170 registered in each record.

The “Page Size” field, like that in the page sequence table 160, stores the value indicating the print size of the intermediate file 170 at which size the printer 400 will actually print.

The “Binding Direction” field, like that in the page sequence table 160, stores the value indicating the direction of binding of a finished book. FIGS. 9 and 10 respectively show the front side and back side of an object to be printed, for a right-bound (right-hand open) book. More specifically, the object to be printed as viewed from the front is mountain folded along a horizontal center line 241, then mountain folded along a vertical center line 240 as viewed from the front, and then subjected to cutting to obtain a right-bound (right-hand open) book whose front cover is section 1 and whose back cover is section 8.

In this way, a finished book is obtained by folding the object to be printed along the center lines 240 and 241. Thus, in order to print the contents of the intermediate files 170 properly on each page of the finished book, the intermediate file 170 which is laid out in each section needs to be rotated in a direction responsive to both the way of folding of the object to be printed and the direction of binding (e.g., the intermediate file 170 laid out in section 4 in FIG. 9 is rotated 180 degrees).

The “Absolute Offset (X-axis Direction)” and “Absolute Offset (Y-axis Direction)” fields store location information describing the position (X and Y coordinates, respectively) of the intermediate file 170 laid out in each section as viewed from the origin O of the printable surface 200.

In the conventional techniques of assignment, data on the intermediate files 170 is registered in this layout information table 850 according to the following procedure. Specifically, in the conventional techniques of assignment, the intermediate file 170 is laid out on the layout reference area 210 provided in each section of the printable surface 200 (see FIGS. 7 and 8).

Then, location information describing the position of the intermediate file 170 on the layout reference area 210 as viewed from the origin O of the printable surface 200 (e.g., X and Y coordinates of the lower left corner of the intermediate file 170 as viewed from the origin O) is stored in the “Absolute Offset (X-axis Direction)” and “Absolute Offset (Y-axis Direction)” fields, the file name of the assigned intermediate file 170 is stored in the “Assignment Result” field, and the value, “assigned,” is stored in the “Assignment State” field.

In this way, the conventional assignment process is performed on the layout information table 850. In the conventional techniques, therefore, it is necessary prior to the assignment process to determine the printer 400 being used for printing and then to previously select the layout information table 850 appropriate to the performance of the printer 400.

However, in actual printing, it may be inconvenient to determine the printer 400 prior to the assignment process. For example in the case where the originally-planned printer 400 cannot be used due to other urgent print requests and accordingly, a different printer must be used for printing, the performance of the printer being used may not allow the use of the same layout information table 850 and require the use of a different layout information table 850 for printing. In this case, reassignment to that different layout information table 850 becomes necessary, which results in reduced operating efficiency.

To solve the above problem, this preferred embodiment performs the following process steps: (1) as the assignment process, registering data on the intermediate files 170 in the page sequence table 160 which is separate from the layout information table 150; (2) at the time when the printer 400 being used for actual printing has been determined, selecting the layout information table 150 appropriate to the printer 400; and (3) establishing a link between the selected layout information table 150 and the page sequence table 160 so that each of the intermediate files 170 can be laid out in each section of the printable surface 200. That is, in this preferred embodiment, the data on the intermediate files 170 can be registered in the page sequence table 160 without depending on the performance of the printer 400. Hereinbelow, the assignment and linking processes according to this preferred embodiment will be described.

FIG. 11 is a diagram for explaining the relationship between a virtual layout reference area 215 and the intermediate file 170. FIGS. 12 to 14 are diagrams for explaining the relative offsets of the lower left corner of a print area 220 as viewed from the lower left corner of the virtual layout reference area 215.

In the assignment process according to this preferred embodiment, the virtual layout reference area 215 is virtually provided which is of nearly identical shape with the layout reference area 210 provided in each section of the printable surface 200. Based on this virtual layout reference area 215, the values of the “Relative Offset (X-axis Direction)” and “Relative Offset (Y-axis Direction)” fields in the page sequence table 160 are computed.

Here, the layout reference area 210 (cf. FIGS. 7 and 8) is a rectangular (or square) area which is provided in each section of the printable surface 200 and which will appear on finished printed matter after cutting. That is, the layout reference area 210 forms, for example in the case of a book, each page of a finished product. Thus, the intermediate file 170 is laid out on this layout reference area 210.

As shown in FIGS. 7 and 8, the print area 220 where the intermediate file 170 is laid out on the printable surface 200 is an area that is printed on an object to be printed. For example when the intermediate file 170 is something such as photographic data that is printed over the entire print area 220, the pages of a book may include both printed and unprinted areas if the cut line is shifted. In order to prevent the occurrence of such a problem, in this preferred embodiment, the print area 220 for the intermediate file 170 is often set to be larger than the layout reference area 210.

Based on the aforementioned virtual layout reference area 215 and the aforementioned layout reference area 210, the assignment process according to this preferred embodiment lays out each of the intermediate files 170 in the virtual layout reference area 215, which is virtually provided and is of nearly identical shape with the layout reference area 210, and then stores the relative position of the lower left corner of the print area 220 for the intermediate file 170 as viewed from the lower left corner of the virtual layout reference area 215 in the “Relative Offset (X-axis Direction)” and “Relative Offset (Y-axis Direction)” fields.

More specifically, let W₀ and H₀ be the width and height of the virtual layout reference area 215, respectively, and W₁ and H₁ be the width and height of the print area 220, respectively (see FIG. 11). When the intermediate file 170 is located so that a center position 211 of the virtual layout reference area 215 and a center position 221 of the print area 220 coincide with each other (see FIG. 12), the value of X1 in equation (1) and the value of Y1 in equation (2) are stored in the “Relative Offset (X-axis Direction)” and “Relative Offset (Y-axis Direction)” fields, respectively.
X1=(W₀−W₁)/2 (1)
Y1=(H₀−H₁)/2 (2)

When the intermediate file 170 is located so that an upper left corner 212 of the virtual layout reference area 215 and an upper left corner 222 of the print area 220 coincide with each other (see FIG. 13), the value of X2 in equation (3) and the value of Y2 in equation (4) are stored in the “Relative Offset (X-axis Direction)” and “Relative Offset (Y-axis Direction)” fields, respectively.
X2=0 (3)
Y2=(H₀−H₁)/2 (4)

When the intermediate file 170 is located so that a lower left corner 213 of the virtual layout reference area 215 and a lower left corner 223 of the print area 220 coincide with each other (see FIG. 14), the value of X3 in equation (5) and the value of Y3 in equation (6) are stored in the “Relative Offset (X-axis Direction)” and “Relative Offset (Y-axis Direction)” fields, respectively.
X3=0 (5)
Y3=0 (6)

Simultaneously with storing of the values of the “Relative Offset (X-axis Direction)” and “Relative Offset (Y-axis Direction)” fields in the page sequence table 160, the file name of the assigned intermediate file 170 and the value, “Assigned,” are stored respectively in the “Assignment Result” and “Assignment State” fields.

The link processor 125 links the data on the intermediate files 170 registered in the page sequence table 160 with the layout information table 150, and performs computations of the values of the “Absolute Offset (X-axis Direction)” and “Absolute Offset (Y-axis Direction)” fields in the layout information table 150.

The layout information table 150 according to this preferred embodiment, as shown in FIG. 6, primarily contains fields (columns) including “Section Number,” “Object Type,” “Object,” “Absolute Offset (X-axis Direction),” “Absolute Offset (Y-axis Direction),” “Page Size,” “Binding Direction,” and “Rotation.” The “Absolute Offset (X-axis Direction),” “Absolute Offset (Y-axis Direction),” “Page Size,” and “Binding Direction” fields are identical to those in the layout information table 850, and thus not described in detail here.

The “Object Type” field stores a description of the type of a printing object registered in each record. For example, in the record whose “Object Type” is “Page,” a printing object corresponding to the intermediate file 170 (i.e., nonunique printing object) is registered.

In the case where the “Object Type” is “Page,” the “Section Number” field stores the value corresponding to each section number such as 1 to 8 in FIGS. 7 and 8. In the case where the “Object Type” is “Register Mark” or “Color Patch,” a minus code “−” is stored in the “Section Number” field.

The “Object” field stores the value for specifying image and/or character data on the object registered in each record.

More specifically, for example when the object is a register mark or a color patch which is not a nonunique printing object, the “Object” field stores the name that designates image and/or character data on the object.

On the other hand, when the object is a nonunique printing object, the “Object” field stores the value showing linkage between each section on the printable surface 200 and each record in the page sequence table 160. The link processor 125 then establishes a link between the layout information table 150 and the specified page sequence table 160 (see FIG. 15).

Thereby, the data on the intermediate files 170 stored in the page sequence table 160 can be referred to from the layout information table 150. For example, the record whose “Section Number” is “2” is linked with the record whose “Page Number” is “2” in the page sequence table 160. From this, it can be found that the intermediate file 170 whose file name is “Body.PS(1)” is laid out in section 2. In this way, the link processor 125 establishes a link between the records in the layout information table 150 and the records in the page sequence table 160.

The “Rotation” field stores a rotation angle of the intermediate file 170 laid out in each section, where the counterclockwise direction is taken as positive. For example, in the case of section 1 (“Section Number”=“1”), the value of the “Rotation” field is “0°” that is, the intermediate file 170 is not rotated (see FIG. 9). In the case of section 5 (“Section Number”=“5”), the value of the “Rotation” field is “180°,” that is, the intermediate file 170 is rotated 180 degrees (see FIG. 9). Thus, the value stored in the “Rotation” field can be used as orientation information describing the orientation of the intermediate file 170 laid out in each section.

In the linking process by the link processor 125, the values of the “Relative Offset (X-axis Direction)” and “Relative Offset (Y-axis Direction)” fields in the linked page sequence table 160, the location information on the layout reference area 210 stored in the layout information table 150 (not shown in FIG. 6), and the value of the “Rotation” field as the orientation information are used to compute absolute location information describing the absolute position of the print area 220 for the intermediate file 170 as viewed from the origin O of the printable surface 200.

More specifically, in the computation of the absolute location information on the print area 220 for the intermediate file 170, the values of the “Relative Offset (X-axis Direction)” and “Relative Offset (Y-axis Direction)” fields in the page sequence table 160 are obtained based on the value of the “Object” field in the layout information table 150. Thereby, the relative positions of the virtual layout reference area 215 and the print area 220 for the intermediate file 170 can be obtained as a vector 232 (see FIG. 11).

Then, like the intermediate file 170, the vector 232 is rotated through an angle responsive to the section number where the intermediate file 170 is located, i.e., rotated by the value of the “Rotation” field. For example, in the cases of FIGS. 17, 18, and 19, the intermediate files 170 are rotated counterclockwise through 90°, 180°, and 270°, respectively, so that their corresponding vectors 232 are rotated counterclockwise through 90°, 180°, and 270°, respectively. On the other hand, in the case of FIG. 16, the intermediate file 170 is not rotated, so the vector 232 is not rotated.

Then, based on data on the layout reference area 210 out of data on each section stored in the layout information table 150, a vector 231 connecting the origin O of the printable surface 200 and the starting point of the vector 232 is obtained. That is, the vector 231 indicates the absolute relative positions of the printable surface 200 and the layout reference area 210.

The vectors 232 and 231 are then added to obtain location information describing the position of the print area 220 for the intermediate file 170 as viewed from the origin O of the printable surface 200, i.e., the absolute relative positions of the printable surface 200 and the print area 220, as a vector 233. The X and Y coordinates of the vector 233 are stored respectively in the “Absolute Offset (X-axis Direction)” and “Absolute Offset (Y-axis Direction)” fields in the layout information table 150.

When changes are made to the selected layout information table 150 and/or the page sequence table 160, the link processor 125 can redo the linking process.

For example, when the value of the “Rotation” filed in the layout information table 150 is changed, the values of the “Absolute Offset (X-axis Direction)” and “Absolute Offset (Y-axis Direction)” fields in the layout information table 150 can be updated based on the values of the “Relative Offset (X-axis Direction)” and “Relative Offset (Y-axis Direction)” fields in the page sequence table 160.

Also, when it becomes necessary to change the layout information table 150 according to the change of the printer 400 being used for printing, the linking process can be redone so that the intermediate files 170 registered in the page sequence table 160 can be relocated in respective sections of the printable surface 200 based on the new layout information table 150.

<3. Procedure for Print Data Processing>

FIG. 20 is a flow chart showing the procedure for print data processing according to this preferred embodiment. In print data processing, a JOB is first generated in order to secure an area for storing the page sequence table 160 and the intermediate files 170 on the mass storage 140 (cf. FIG. 2) (S101).

Then, the contents file 175 is inputted from the contents-data editing apparatus 300 to the print data processing apparatus 100 and into the mass storage 140 (S102). The contents file 175 stored in the mass storage 140 is converted into the intermediate files 170 by the contents-file converter 121 (cf. FIG. 2) (S103). In step S103, along with the conversion into the intermediate files 170, a total number of pages of the contents file 175 and the size of each page are obtained.

Further, in the print data processing according to this preferred embodiment, independent of the generation of the intermediate files 170, the page-sequence-table generator 122 generates the page sequence table 160 (cf. FIG. 2) (S1104).

Then, the intermediate files 170 generated in step S103 are registered in the page sequence table 160 generated in step S104 (S105). More specifically, the input unit 190 specifies the intermediate files 170, and the assignment processor 123 computes the values to be stored in the “Relative Offset (X-axis Direction)” and “Relative Offset (Y-axis Direction)” fields in the page sequence table 160 and registers data on the intermediate files 170 into the page sequence table 160. All the intermediate files 170 are then subjected to the assignment process in step S105 (S106).

Then, at the time when the printer 400 being used for actual printing has been determined, the layout-information selector 126 selects, according to the operator's instructions, the layout information table 150 appropriate to the printer 400 being used for printing (S107).

Then, the link processor 125 performs the linking process in which a link is established between the page sequence table 160 which contains registered data on the intermediate files 170 and the layout information table 150 selected by the layout-information selector 126, and the values of the “Absolute Offset (X-axis Direction)” and “Absolute Offset (Y-axis Direction)” fields are computed so that each of the intermediate files 170 can be laid out in each section of the printable surface 200 (S108). The layout information table 150 and the page sequence table 160 after the linking process are then transmitted to the printer 400, which completes the print data processing.

<4. Advantages of Printing System of Preferred Embodiment>

As so far described, in the print data processing apparatus 100 according to this preferred embodiment, the data on the intermediate files 170, out of data on the printing objects laid out on the printable surface 200, is managed by being registered in the page sequence table 160.

The process of laying out the intermediate file 170 in each section, e.g., 1-8, on the printable surface 200 can be implemented by establishing a link between the page sequence table 160 which contains registered data on the intermediate files 170 and the layout information table 150. That is, it is not necessary in the print data processing apparatus 100 of this preferred embodiment to select the layout information table 150 before registering data on the intermediate files 170.

Thus, even if the printer 400 being used for printing has not yet been determined, the data on the intermediate files 170 can be registered. This allows efficient print data processing.

<5. Modifications>

While the preferred embodiment of the present invention has been described so far, the present invention is not limited to the above-described embodiment.

Although in the above-described preferred embodiment, the print data processing apparatus 100 converts the contents file 175 inputted from the contents-data editing apparatus 300 into the intermediate files 170 and performs imposition in which the intermediate files 170 are laid out on a printing plate, the present invention is not limited thereto. For example, the print data processing apparatus 100 may generate and convert the contents file 175 and then perform imposition.

As another alternative, the print data processing apparatus 100 may input the converted intermediate files 170 into the information processor 500 after conversion of the contents file 175, and the information processor 500 may perform imposition. In other words, there may be a print data processing system 700 which is constructed of the print data processing apparatus 100 serving as an information processor for performing contents-file conversion; and of the information processor 500 which is electrically connected to the print data processing apparatus 100 over the network 900 and which performs imposition as described in the above preferred embodiment.

Further, although the page-sequence-table generator 122 according to the above-described preferred embodiment generates the page sequence table 160 by using the size of a book, a total number of pages, and the binding direction, all of which are determined at the stage of planning a book, the present invention is not limited thereto. As above described, the layout information table 150 stores data including the page size, a total number of pages, and the binding direction which are necessary for generation of the page sequence table 160. Thus, for example, those data stored in the layout information table 150 may be used for generation of the page sequence table 160.

Still further, although the link processor 125 according to the above-described preferred embodiment establishes one-to-one linkage between the records in the layout information table 150 and the records in the page sequence table 160, the present invention is not limited thereto. For example, one record in the page sequence table 160 may be linked with a plurality of records in the layout information table 150. This allows the same intermediate file 170 to be printed in a plurality of sections on the printable surface 200.

Still further, although the same data is stored in the “Binding Direction” field in each record in the page sequence table 160 according to the above-described preferred embodiment, the present invention is not limited thereto. For example, a separate table may be generated for such a field whose data is the same in each record, and a combination of the two tables, the separate table generated and the page sequence table 160 from which the above field, e.g., the “Binding Direction” field, is excluded, may be used as a page information table. The same can be said of the layout information table 150.

Still further, although in the procedure for print data processing according to the above-described preferred embodiment (see FIG. 20), the layout information table 150 appropriate to the printer 400 being used for printing is selected at the time when the printer 400 being used for actual printing has been determined, the present invention is not limited thereto. For example, the selection of the layout information table 150 may be performed in parallel with the generation of the intermediate files 170 in step S103 and the generation of the page sequence table 160 in step S104.

Still further, although in the above-described preferred embodiment, the intermediate files 170 are registered in one-to-one correspondence with respective pages in the page sequence table 160, the present invention is not limited thereto. For example, when a single intermediate file 170 (print data) will appear across two separate (right and left) pages as shown in FIG. 21, the same intermediate file 170 may be registered in two records corresponding to the right and left pages in the page sequence table 160.

While the invention has been shown and described in detail, the foregoing description is in all aspects illustrative and not restrictive. It is therefore understood that numerous modifications and variations can be devised without departing from the scope of the invention.

1. A print data processing apparatus for dividing a printable surface, which depends on a printer, into a plurality of sections and laying out printing objects in respective ones of said plurality of sections,
said print data processing apparatus comprising:
a storage for holding a plurality of separate tables including
a plurality of layout information tables provided for each size of said printable surface and each containing, at least, data on respective ones of said plurality of sections and data on said printing objects laid out in respective ones of said plurality of sections, and
a page information table containing, as nonunique data, data on nonunique ones of said printing objects which are not unique to said printable surface;
a register for registering said nonunique data in said page information table;
a selector for selecting one of said plurality of layout information tables which is appropriate to a printer being used for printing; and
a linker for establishing a link between said nonunique data in said page information table and data corresponding to said nonunique data in a selected layout information table obtained by said selector, so that said nonunique printing objects are laid out in corresponding ones of said plurality of sections.

2. The print data processing apparatus according to claim 1, wherein
said plurality of sections each include a layout reference area used for layout of said printing objects,
said nonunique data includes first location information describing relative positions of said nonunique printing objects and virtual layout reference areas of nearly identical shape with said layout reference areas, when said nonunique printing objects are laid out on said virtual layout reference areas,
said layout information tables each contain as data on said nonunique printing objects:
orientation information describing an orientation of said nonunique printing object in a target one of said plurality of sections;
second location information describing a position of said layout reference area in said target section as viewed from a reference point on said printable surface; and
third location information computed based on said orientation information and said first and second location information and describing a position of said nonunique printing object in said target section as viewed from said reference point,
said register computes said first location information and stores nonunique data including said first location information in said page information table, and
said linker computes and stores said third location information as data on said nonunique printing objects.

3. The print data processing apparatus according to claim 2, wherein
said linker can reestablish a link when changes are made to data on said nonunique printing objects stored in said selected layout information table or to said nonunique data stored in said page information table.

4. The print data processing apparatus according to claim 2, wherein
after linking said selected layout information table and said page information table, said linker can establish a link between a layout information table which is different from said selected layout information table and said page information table.

5. The print data processing apparatus according to claim 1, wherein
print data of data on said nonunique printing objects is generated by a converter for converting a print data file.

6. A program being readable by a computer and for dividing a printable surface, which depends on a printer, into a plurality of sections and laying out printing objects in respective ones of said plurality of sections,
said computer having a storage for holding a plurality of separate tables including:
a plurality of layout information tables provided for each size of said printable surface and each containing, at least, data on respective ones of said plurality of sections and data on said printing objects laid out in respective ones of said plurality of sections; and
a page information table containing, as nonunique data, data on nonunique ones of said printing objects which are not unique to said printable surface,
in execution of said program, said computer performing the steps of:
(a) registering said nonunique data in said page information table;
(b) selecting one of said plurality of layout information tables which is appropriate to a printer being used for printing; and
(c) establishing a link between said nonunique data in said page information table and data corresponding to said nonunique data in a layout information table selected in said step (b), so that said nonunique printing objects are laid out in corresponding ones of said plurality of sections.

7. A print data processing method for dividing a printable surface, which depends on a printer, into a plurality of sections and laying out printing objects in respective ones of said plurality of sections based on a page information table and a plurality of layout information table,
said plurality of layout information tables being provided for each size of said printable surface and each containing, at least, data on respective ones of said plurality of sections and data on said printing objects laid out in respective ones of said plurality of sections,
said page information table containing nonunique data or data on printing objects which are not unique to said printable surface,
said print data processing method comprising the steps of:
(a) registering said nonunique data in said page information table;
(b) selecting one of said plurality of layout information tables which is appropriate to a printer being used for printing; and
(c) establishing a link between said nonunique data in said page information table and data corresponding to said nonunique data in a layout information table selected in said step (b), so that said nonunique printing objects are laid out in corresponding ones of said plurality of sections.
